(19) United States
(12) Patent Application Publication
(10) Pub. No.: US 2024/0330828 A1
(43) Pub. Date: Oct. 3, 2024

(54) SYSTEMS AND METHODS RELATING TO ESTIMATING LIFT IN TARGET METRICS OF CONTACT CENTERS

(71) Applicant: GENESYS CLOUD SERVICES, INC., MENLO PARK, CA (US)

(72) Inventor: ANKIT PAT, MARKHAM (CA)

(73) Assignee: GENESYS CLOUD SERVICES, INC., MENLO PARK, CA (US)

(21) Appl. No.: 18/129,175

(22) Filed: Mar. 31, 2023

(51) Int. Cl. G06Q 10/0639; G06Q 10/04; H04M 3/51

(52) U.S. Cl. CPC G06Q 10/06393; G06Q 10/04; H04M 3/5175; H04M 2203/401

(57) ABSTRACT

A method of determining operational advantages associated with prospective use by a contact center of a predictive routing model. The operational advantages may include quantifying an expected lift in a target metric. The method includes: receiving an operational dataset associated with a time period of operation for the contact center; providing the predictive routing model configured to predict a score for the target metric for a given agent for a given interaction based on agent characteristic data associated with the given agent and interaction data associated with the given interaction; and, using the received predictive routing model, operational dataset, and agent characteristic data, computing the expected lift in the target metric assuming use of the predictive routing model during the time period. The algorithm used to compute the lift in the target metric is based on individual agent occupancy levels.

### BACKGROUND

The present invention generally relates to telecommunications systems and methods, as well as the analysis of contact center metrics. More particularly, the present invention pertains to the optimization of key performance indicators and predictions related thereto, including the benefits related to both for regarding improving operations for contact centers.

### BRIEF DESCRIPTION OF THE INVENTION

The present invention includes a method of determining operational advantages associated with prospective use by a contact center of a predictive routing model. The operational advantages may include quantifying an expected lift in a target metric. The method may include the steps of: receiving an operational dataset associated with a time period of operation for the contact center, the operational dataset may include interaction data associated with interactions with customers handled by agents of the contact center during the time period; receiving agent characteristic data for each of the agents of the contact center; providing the predictive routing model that is configured to predict a score for the target metric for a given agent for a given interaction based on agent characteristic data associated with the given agent and interaction data associated with the given interaction; and, using the received predictive routing model, operational dataset, and agent characteristic data, computing the expected lift in the target metric assuming use of the predictive routing model during the time period. The first algorithm may compute the lift in the target metric based on individual agent occupancy levels pursuant to the steps of: dividing the operational dataset into sequentially occurring timeslots; for each timeslot of the time period, performing the following steps, which, when described in relation to an exemplary first timeslot of the timeslots, include: a) determining, based on the operational dataset, an availability for each of the agents during the first timeslot, the availability may include an actual portion of the first timeslot that the agent is available; b) using the new predictive routing model to determine a score for the target metric for each of the agents for each of the interactions during the timeslot; c) for each of the interactions in the first timeslot, calculating an agent routing probability, wherein for a given agent, wherein the calculation of the agent routing probability takes into account a probability that the interaction would be routed to the given agent based on the availability of the given agent and the score for the target metric of the given agent relative to the scores of the other agents; d) for each agent, calculating an agent specific component of an interaction expected value, wherein for a given agent the calculation of the agent specific component of interaction expected value includes multiplying the agent routing probability of the given agent by the score for the given agent; e) calculating the interaction expected value for each of the interactions of the first timeslot, wherein, for a given interaction, the interaction expected value includes summing the agent specific component for each of the agents as calculated for the given interaction; f) calculating an average timeslot predicted score for the target metric for the first timeslot as an average of the interaction expected values as calculated for the interactions of the first timeslot; calculating, based on the average timeslot predicted scores calculated for each of the timeslots, a time period predicted score for the target metric; and comparing the time period predicted score for the target metric against a baseline score for the target metric for the time period to compute the expected lift.

These and other features of the present application will become more apparent upon review of the following detailed description of the example embodiments when taken in conjunction with the drawings and the appended claims.

### BRIEF DESCRIPTION OF THE DRAWINGS

A more complete appreciation of the present invention will become more readily apparent as the invention becomes better understood by reference to the following detailed description when considered in conjunction with the accompanying drawings, in which like reference symbols indicate like components. The drawings include the following figures.

FIG. 1 depicts a schematic block diagram of a communications infrastructure or contact center in accordance with exemplary embodiments of the present invention and/or with which exemplary embodiments of the present invention may be enabled or practiced.

FIG. 2 is a diagram illustrating an embodiment of a predictive routing server operating as part of the contact center system.

FIG. 3 is a flowchart illustrating an embodiment of a process for estimating expected improvement in a target metric of a contact center.

FIG. 4 is a method for calculating expected lift in a target metric.

FIG. 5 is a method illustrating an algorithm for use in calculating lift in a target metric.

FIG. 6A is a diagram illustrating an embodiment of a computing device.

FIG. 6B is a diagram illustrating an embodiment of a computing device.

### DETAILED DESCRIPTION

For the purposes of promoting an understanding of the principles of the invention, reference will now be made to the exemplary embodiments illustrated in the drawings and specific language will be used to describe the same. It will be apparent, however, to one having ordinary skill in the art that the detailed material provided in the examples may not be needed to practice the present invention. In other instances, well-known materials or methods have not been described in detail in order to avoid obscuring the present invention. As used herein, language designating nonlimiting examples and illustrations includes “e.g.”, “i.e.”, “for example”, “for instance” and the like. Further, reference throughout this specification to “an embodiment”, “one embodiment”, “present embodiments”, “exemplary embodiments”, “certain embodiments” and the like means that a particular feature, structure, or characteristic described in connection with the given example may be included in at least one embodiment of the present invention. Particular features, structures or characteristics may be combined in any suitable combinations and/or sub-combinations in one or more embodiments or examples. Those skilled in the art will recognize from the present disclosure that the various embodiments may be computer implemented using many different types of data processing equipment, with embodiments being implemented as an apparatus, method, or computer program product.

The flowcharts and block diagrams provided in the figures illustrate architecture, functionality, and operation of possible implementations of systems, methods, and computer program products in accordance with example embodiments of the present invention. In this regard, it will be understood that each block of the flowcharts and/or block diagrams—or combinations of those blocks—may represent a module, segment, or portion of program code having one or more executable instructions for implementing the specified logical functions. It will similarly be understood that each of block of the flowcharts and/or block diagrams—or combinations of those blocks—may be implemented by special purpose hardware-based systems or combinations of special purpose hardware and computer instructions performing the specified acts or functions. Such computer program instructions also may be stored in a computer-readable medium that can direct a computer or other programmable data processing apparatus to function in a particular manner, such that the program instructions in the computer-readable medium produces an article of manufacture that includes instructions by which the functions or acts specified in each block of the flowcharts and/or block diagrams—or combinations of those blocks—are implemented.

The present disclosure is directed to a system and method of estimating expected improvement in a target metric of a contact center. When operators of contact centers are seeking to upgrade or otherwise alter existing architecture of a contact center, it may be difficult to quantify the expected benefits to the contact center. This may be true in the addition of a predictive routing system to traditional interaction routing architecture for a contact center. The deployment of a predictive routing system to route interactions in a contact center may use, among other inputs, accumulated agent and customer-agent interaction data, which can permit the contact center operator to analyze omnichannel interactions and outcomes and generate models to predict outcomes. From this analysis by the predictive routing system, combined with machine learning, an optimal match between waiting interactions and available agents may be determined, and the interactions routed accordingly. Reports may also be generated on predicted versus actual outcomes of customer-agent interactions. Further training of the machine-learning model of the predictive routing may be accomplished from the use of actual outcomes, which may improve the accuracy of predicted outcomes between similar customer profiles and agent profiles.

When deciding on whether to implement a predictive routing system as part of an existing contact center, it is often desirable for an operator of the contact center to have a quantitative analysis of the benefits of the addition. Contact centers with an existing store of historic data that includes the type of input data for a predictive routing server, such as agent data and customer-agent interaction data, may be able to leverage the historic data into estimating and modeling how the contact center might have performed with the predictive routing server over a baseline of actual performance information over the same time period. From the modeling of the historic data, a simulation can be performed on historic data to determine agent availability by scoring all agents who are part of a daily agent pool and selecting the maximum scored agent among the pool. Simulations may be run over varying percentages of availability, such as 100% or 50%, and the results verified. In addition, a generated lift curve could also reveal issues underlying with the scoring model as to how well the model discriminates between agents and how reliable the scores are.

### Contact Center Systems

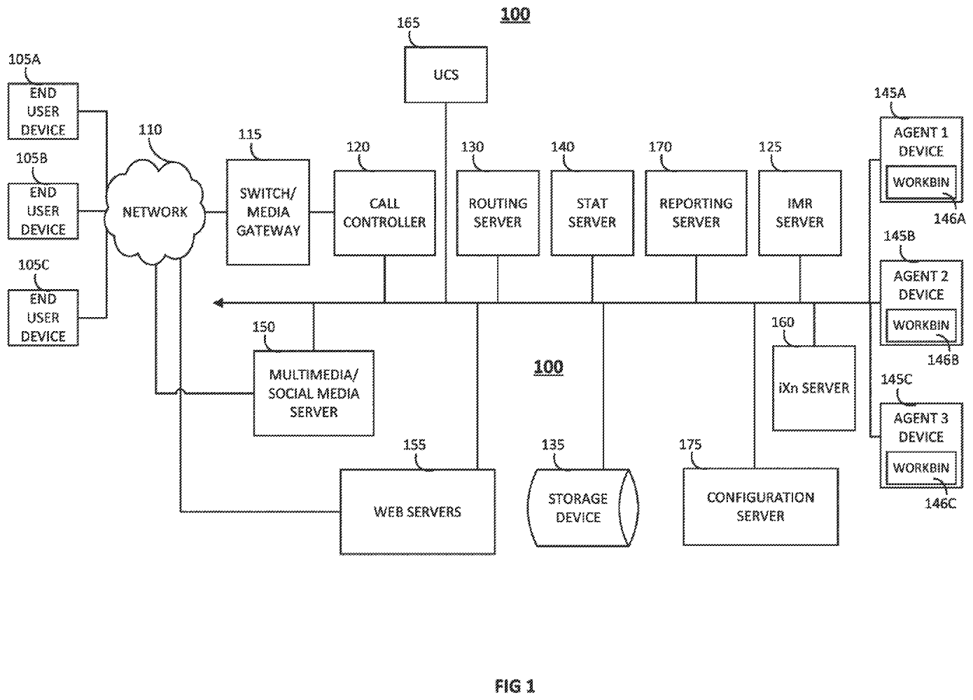

FIG. 1 is a diagram illustrating an embodiment of a communication infrastructure, indicated generally at 100. For example, FIG. 1 illustrates a system for supporting a contact center in providing contact center services. The contact center may be an in-house facility to a business or enterprise for serving the enterprise in performing the functions of sales and service relative to the products and services available through the enterprise. In another aspect, the contact center may be operated by a third-party service provider. In an embodiment, the contact center may operate as a hybrid system in which some components of the contact center system are hosted at the contact center premises and other components are hosted remotely (e.g., in a cloud-based environment). The contact center may be deployed on equipment dedicated to the enterprise or third-party service provider, and/or deployed in a remote computing environment such as, for example, a private or public cloud environment with infrastructure for supporting multiple contact centers for multiple enterprises. The various components of the contact center system may also be distributed across various geographic locations and computing environments and not necessarily contained in a single location, computing environment, or even computing device.

Components of the communication infrastructure indicated generally at 100 include: a plurality of end user devices 105A, 105B, 105C; a communications network 110; a switch/media gateway 115; a call controller 120; an IMR server 125; a routing server 130; a storage device 135; a stat server 140; a plurality of agent devices 145A, 145B, 145C and associated workbins 146A, 146B, 146C; a multimedia/social media server 150; web servers 155; an iXn server 160; a UCS 165; a reporting server 170; and a configuration server 175.

In an embodiment, the contact center system manages resources (e.g., personnel, computers, telecommunication equipment, etc.) to enable delivery of services via telephone or other communication mechanisms. Such services may vary depending on the type of contact center and may range from customer service to help desk, emergency response, telemarketing, order taking, etc.

Customers, potential customers, or other end users (collectively referred to as customers or end users) desiring to receive services from the contact center may initiate inbound communications (e.g., telephony calls, emails, chats, etc.) to the contact center via end user devices 105A, 105B, and 105C (collectively referenced as 105). Each of the end user devices 105 may be a communication device conventional in the art, such as a telephone, wireless phone, smart phone, personal computer, electronic tablet, laptop, etc., to name some non-limiting examples. Users operating the end user devices 105 may initiate, manage, and respond to telephone calls, emails, chats, text messages, web-browsing sessions, and other multi-media transactions. While three end user devices 105 are illustrated at 100 for simplicity, any number may be present.

Inbound and outbound communications from and to the end user devices 105 may traverse a network 110 depending on the type of device that is being used. The network 110 may be a communication network of telephone, cellular, and/or data services and may also include a private or public switched telephone network (PSTN), local area network (LAN), private wide area network (WAN), and/or public WAN such as the Internet, to name a non-limiting example. The network 110 may also include a wireless carrier network including a code division multiple access (CDMA) network, global system for mobile communications (GSM) network, or any wireless network/technology conventional in the art, including but not limited to 3G, 4G, LTE, etc.

In an embodiment, the contact center system includes a switch/media gateway 115 coupled to the network 110 for receiving and transmitting telephony calls between the end users and the contact center. The switch/media gateway 115 may include a telephony switch or communication switch configured to function as a central switch for agent level routing within the center. The switch may be a hardware switching system or a soft switch implemented via software. For example, the switch 115 may include an automatic call distributor, a private branch exchange (PBX), an IP-based software switch, and/or any other switch with specialized hardware and software configured to receive Internet-sourced interactions and/or telephone network-sourced interactions from a customer, and route those interactions to, for example, an agent telephony or communication device. In this example, the switch/media gateway establishes a voice path/connection (not shown) between the calling customer and the agent telephony device, by establishing, for example, a connection between the customer's telephony device and the agent telephony device.

In an embodiment, the switch is coupled to a call controller 120 which may, for example, serve as an adapter or interface between the switch and the remainder of the routing, monitoring, and other communication-handling components of the contact center. The call controller 120 may be configured to process PSTN calls, VoIP calls, etc. For example, the call controller 120 may be configured with computer-telephony integration (CTI) software for interfacing with the switch/media gateway and contact center equipment. In an embodiment, the call controller 120 may include a session initiation protocol (SIP) server for processing SIP calls. The call controller 120 may also extract data about the customer interaction, such as the caller's telephone number (e.g., the automatic number identification (ANI) number), the customer's internet protocol (IP) address, or email address, and communicate with other components of the system 100 in processing the interaction.

In an embodiment, the system 100 further includes an interactive media response (IMR) server 125. The IMR server 125 may also be referred to as a self-help system, a virtual assistant, etc. The IMR server 125 may be similar to an interactive voice response (IVR) server, except that the IMR server 125 is not restricted to voice and additionally may cover a variety of media channels. In an example illustrating voice, the IMR server 125 may be configured with an IMR script for querying customers on their needs. For example, a contact center for a bank may tell customers via the IMR script to ‘press 1’ if they wish to retrieve their account balance. Through continued interaction with the IMR server 125, customers may be able to complete service without needing to speak with an agent. The IMR server 125 may also ask an open-ended question such as, “How can I help you?” and the customer may speak or otherwise enter a reason for contacting the contact center. The customer's response may be used by a routing server 130 to route the call or communication to an appropriate contact center resource.

If the communication is to be routed to an agent, the call controller 120 interacts with the routing server (also referred to as an orchestration server) 130 to find an appropriate agent for processing the interaction. The selection of an appropriate agent for routing an inbound interaction may be based, for example, on a routing strategy employed by the routing server 130, and further based on information about agent availability, skills, and other routing parameters provided, for example, by a statistics server 140.

In an embodiment, the routing server 130 may query a customer database, which stores information about existing clients, such as contact information, service level agreement (SLA) requirements, nature of previous customer contacts and actions taken by the contact center to resolve any customer issues, etc. The database may be, for example, Cassandra or any NoSQL database, and may be stored in a mass storage device 135. The database may also be a SQL database and may be managed by any database management system such as, for example, Oracle, IBM DB2, Microsoft SQL server, Microsoft Access, PostgreSQL, etc., to name a few non-limiting examples. The routing server 130 may query the customer information from the customer database via an ANI or any other information collected by the IMR server 125.

Once an appropriate agent is identified as being available to handle a communication, a connection may be made between the customer and an agent device 145A, 145B and/or 145C (collectively referenced as 145) of the identified agent. While three agent devices are illustrated in FIG. 1 for simplicity, any number of devices may be present. Collected information about the customer and/or the customer's historical information may also be provided to the agent device for aiding the agent in better servicing the communication and additionally to the contact center admin/supervisor device for managing the contact center. In this regard, each device 145 may include a telephone adapted for regular telephone calls, VoIP calls, etc. The device 145 may also include a computer for communicating with one or more servers of the contact center and performing data processing associated with contact center operations, and for interfacing with customers via voice and other multimedia communication mechanisms.

The contact center system 100 may also include a multimedia/social media server 150 for engaging in media interactions other than voice interactions with the end user devices 105 and/or web servers 155. The media interactions may be related, for example, to email, vmail (voice mail through email), chat, video, text-messaging, web, social media, co-browsing, etc. The multi-media/social media server 150 may take the form of any IP router conventional in the art with specialized hardware and software for receiving, processing, and forwarding multi-media events.

The web servers 155 may include, for example, social interaction site hosts for a variety of known social interaction sites to which an end user may subscribe, such as Facebook, Twitter, Instagram, etc., to name a few non-limiting examples. In an embodiment, although web servers 155 are depicted as part of the contact center system 100, the web servers may also be provided by third parties and/or maintained outside of the contact center premise. The web servers 155 may also provide web pages for the enterprise that is being supported by the contact center system 100. End users may browse the web pages and get information about the enterprise's products and services. The web pages may also provide a mechanism for contacting the contact center via, for example, web chat, voice call, email, web real-time communication (WebRTC), etc. Widgets may be deployed on the websites hosted on the web servers 155.

In an embodiment, deferrable interactions/activities may also be routed to the contact center agents in addition to real-time interactions. Deferrable interaction/activities may include back-office work or work that may be performed off-line such as responding to emails, letters, attending training, or other activities that do not entail real-time communication with a customer. An interaction (iXn) server 160 interacts with the routing server 130 for selecting an appropriate agent to handle the activity. Once assigned to an agent, an activity may be pushed to the agent, or may appear in the agent's workbin 146A, 146B, 146C (collectively 146) as a task to be completed by the agent. The agent's workbin may be implemented via any data structure conventional in the art, such as, for example, a linked list, array, etc. In an embodiment, a workbin 146 may be maintained, for example, in buffer memory of each agent device 145.

In an embodiment, the mass storage device(s) 135 may store one or more databases relating to agent data (e.g., agent profiles, schedules, etc.), customer data (e.g., customer profiles), interaction data (e.g., details of each interaction with a customer, including, but not limited to: reason for the interaction, disposition data, wait time, handle time, etc.), and the like. In another embodiment, some of the data (e.g., customer profile data) may be maintained in a customer relations management (CRM) database hosted in the mass storage device 135 or elsewhere. The mass storage device 135 may take form of a hard disk or disk array as is conventional in the art.

In an embodiment, the contact center system may include a universal contact server (UCS) 165, configured to retrieve information stored in the CRM database and direct information to be stored in the CRM database. The UCS 165 may also be configured to facilitate maintaining a history of customers' preferences and interaction history, and to capture and store data regarding comments from agents, customer communication history, etc.

The contact center system may also include a reporting server 170 configured to generate reports from data aggregated by the statistics server 140. Such reports may include near real-time reports or historical reports concerning the state of resources, such as, for example, average wait time, abandonment rate, agent occupancy, etc. The reports may be generated automatically or in response to specific requests from a requestor (e.g., agent/administrator, contact center application, etc.).

The configuration server 175 may be configured to store agent profile information associated with agents that operate an agent device 145. The information associate with an agent access through configuration server 175 may include, but are not limited to, a unique agent identification number, agent activity, an agent grouping of the contact center, language skills, and assignment to particular contexts of interactions. The configuration server 175 may also associate certain statistic from reporting server 175 with particular agents. The associated statistics may include, but are not limited to, statistics concerning agent utilization, first call resolution, average handle time, and retention rate.

The various servers of FIG. 1 may each include one or more processors executing computer program instructions and interacting with other system components for performing the various functionalities described herein. The computer program instructions are stored in a memory implemented using a standard memory device, such as for example, a random-access memory (RAM). The computer program instructions may also be stored in other non-transitory computer readable media such as, for example, a CD-ROM, flash drive, etc. Although the functionality of each of the servers is described as being provided by the particular server, a person of skill in the art should recognize that the functionality of various servers may be combined or integrated into a single server, or the functionality of a particular server may be distributed across one or more other servers without departing from the scope of the embodiments of the present invention.

In an embodiment, the terms “interaction” and “communication” are used interchangeably, and generally refer to any real-time and non-real-time interaction that uses any communication channel including, without limitation, telephony calls (PSTN or VoIP calls), emails, vmails, video, chat, screen-sharing, text messages, social media messages, WebRTC calls, etc.

In an embodiment, the premises-based platform product may provide access to and control of components of the system 100 through user interfaces (UIs) present on the agent devices 145A-C. Within the premises-based platform product, the graphical application generator program may be integrated which allows a user to write the programs (handlers) that control various interaction processing behaviors within the premises-based platform product.

As noted above, the contact center may operate as a hybrid system in which some or all components are hosted remotely, such as in a cloud-based environment. For the sake of convenience, aspects of embodiments of the present invention will be described below with respect to providing modular tools from a cloud-based environment to components housed on-premises.

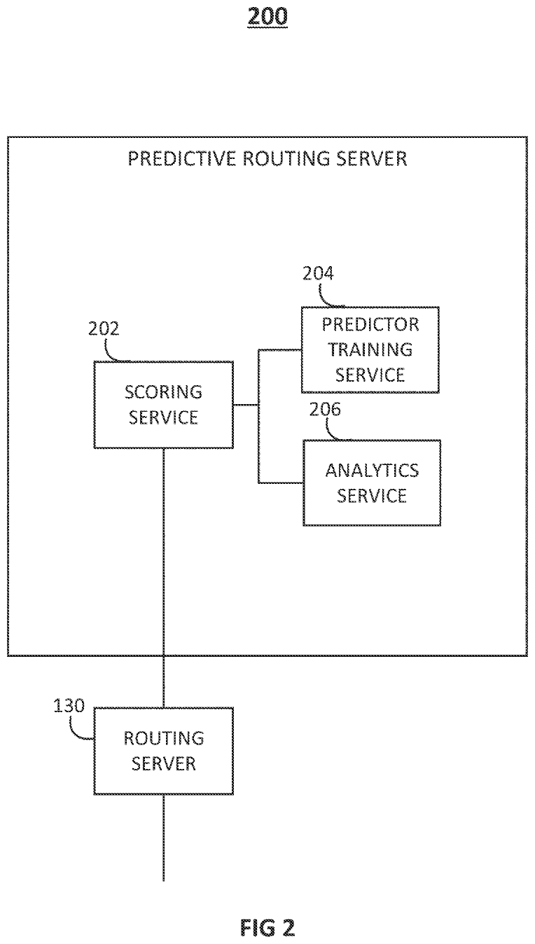

FIG. 2 is a diagram illustrating an embodiment of a predictive routing server operating as part of the contact center system. A predictive routing server 200, operatively coupled with routing server 130 and contact center 100 (FIG. 1), may be configured to use historical and real-time data, along with artificial intelligence, to identify factors that influence customer-to-business interactions. These data may include favored communication channel, past product purchases and service requests, and recent transaction activity. The predictive routing server 200 may combine this information with agent profiles and factors (e.g., agent skills, interaction history, and business outcome data) to predict ideal customer-agent matches. The predictive routing server 200 may include the core machine learning server that is capable of performing a number of functions, as described herein. In addition, the predictive routing server 200 may host a number of services within, including a scoring service 202, model training service 204, and an analytics server 206.

The predictive routing server 200 may permit inputs of customer profile data, agent profile data, interaction data, and outcome data associated with the interaction data. The inputs may be obtained from a storage device 135, a configuration server 175, or other appropriate hardware for maintaining the data. The predictive routing server 200 is configured to perform batch processing to run a number of analytical processes, for example variance analysis and feature analysis on historical data. A variance analysis performed by the predictive routing server 200 may provide analysis on how a selected target metric may vary across different agent populations. A variance analysis may be generated for inter-agent variance, which may show how well individual agents perform, including an identification of the highest-performing and weakest agents. A variance analysis may also be generated for agent variance, which may show the range of agent performance for each category as specified group of agents. Examples of a grouping of agents can include, but are not limited to, an agent's role and an agent's skills. A feature analysis performed by the predictive routing server 200 is configured to generate predictors and models for the predictive routing server 200. In particular, generated predictors and models enables the contact center operator to determine which factors have the most impact on a selected target metric. Examples of factors that determine the impact on a selected target metric may include agent characteristics and agent behavior, customer characteristics, and behavior.

The predictive routing server 200 may be configured to train predictive models for real-time scoring use. In other words, a generated predictive model, detailed below, may be used to determine the routing of incoming interaction to an available agent. The predictive model used by the predictive routing server 200 may generate, upon receipt of the routing server 130 of an interaction, a real-time list of agents that are available to handle the interaction, which are scored against the model. The interaction may then be routed to one of the available agents based on the scoring of the model. Additionally, the predictive routing server 200 may store predicted and actual outcomes of agent-customer interactions and generate reports and dashboards tracking performance of models for target metrics.

The scoring service 202 may be configured to receive a model trained on the predictive routing server 200. The received trained model can be available on the scoring server 202 as a worker to take scoring requests that may come from other systems of the contact center 100. In an embodiment, the predictive routing server 200 may have multiple workers of scoring server 202 to score requests for a number of target metrics. The scoring server 202 operating as a worker can be available as a scoring service in contact center environment. In an embodiment, dedicated instances of scoring service 202 are provided for each provided scoring service of the predictive routing server 200.

The model training service 204 may be configured as a dedicated service to analyze received data and train models for the predictive routing server 200. Model training service 204 may be configured to train a model by (i) transforming historical data, (ii) generating new features, (iii) aggregating outcomes, (iv) running feature analysis, and (v) training and testing for regression and classification models. The model training service 204 may be configured to utilize machine learning algorithms to train models. Machine learning algorithms deployed by the model training server 204 may include, but are not limited to, neural networks and decision trees.

The analytics service 206 may be configured to perform analysis on different datasets to help guide configuration of usable datasets and target metrics to optimize datasets to consume for model training. The analytics service 206 may perform aggregation on datasets as part of the scoring service worker. In an embodiment, the analytics service may include dedicated processes to run feature analysis, variance analysis, simulations, and, as discussed more below, lift estimation.

However, embodiments of the present disclosure are not limited to a particular architecture for the contact center. For example, embodiments of the present disclosure may also be applied in data centers operated directly by the contact center or within the contact center, where resources within the data center may be dynamically and programmatically allocated and/or deallocated from a group. Embodiments of the present disclosure may also be deployed with remotely-hosted or cloud-based infrastructure.

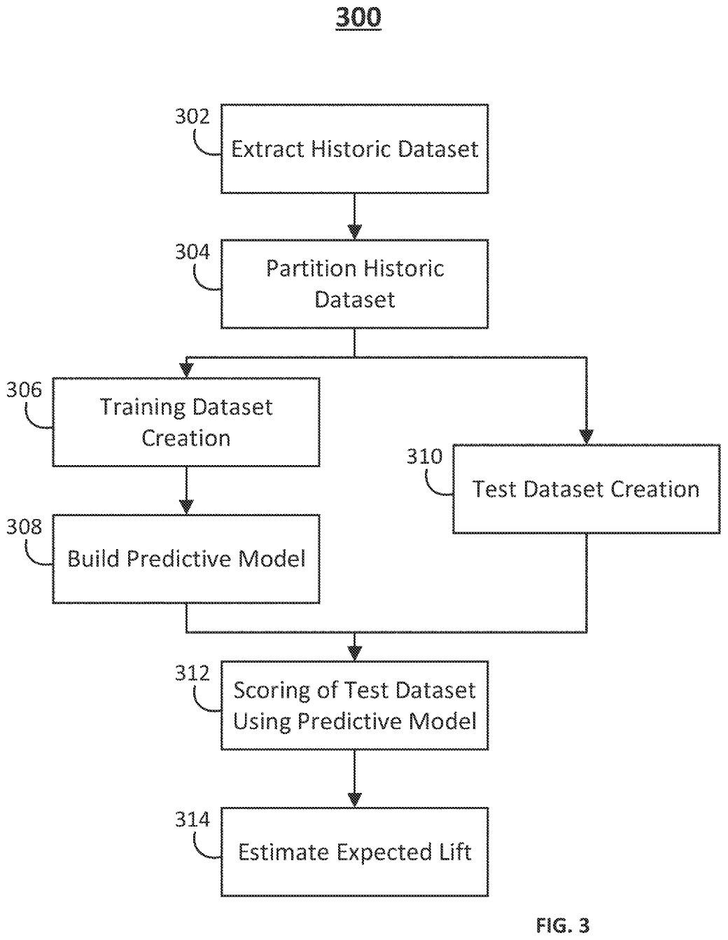

FIG. 3 is a flowchart illustrating an embodiment of a process for estimating expected improvement in a target metric of a contact center, indicated generally at 300. A target metric having its improvement estimated may include, but not be limited to, first call resolution, net promoter score (NPS), average handle time (AHT), and retention rate.

The process 300 begins and at operation 302, extraction of an historic dataset from a contact center database over a prior time interval occurs. For example, a contact center may generate through its daily operation a voluminous amount of historic data from prior interactions between customers and agents handled by the contact center. The historic dataset may contain interaction data, agent data, customer data, and results from customer satisfaction surveys (CSAT).

The interaction data from the historic dataset may include identification of the customer and the agent that interacted during a particular interaction. For example, each customer may have a unique identification number associated with the customer profile that specifically identifies the customer that contacted the contact center. As an additional example, each agent may have a unique identification number or employee number associated with the agent of the contact center. The customer unique identification number and the agent unique identification number could be included in the interaction data. Additional information associated with, or contained in, the interaction data may include interaction duration, response time, queue time, routing point time, total duration, customer engagement time, customer hold time, and interaction handle time. The interaction data may also contain the context of the interaction, which categorizes the purpose of the interaction. For example, in a contact center that handles a multiplicity of different types of inbound inquiries from a customer, examples of the different types of inbound inquiries might include billing, sales, and technical support. The context of “sales” could be associated with the interaction data for a customer that contacts the contact center of the business to inquiry about purchasing a new service.

In an embodiment, the set time interval is a set amount of historic data as determined by a particular time interview. For example, the most-recent six months' worth of data from the contact center could be the set time interval for the amount of historic data. The time interval may be of one a continuous length of time or a number of distinct time intervals. The time interval may seek to omit time periods where there is an absence of data from the historic data, due to a loss of data from the storage medium, for example. The length of the set time interval should be appropriately set to permit sufficient data for building the predictive model and analysis by an analytics server.

The historic database may also contain information concerning the outcomes for the interactions handled through the contact center between the agents and customers. In an embodiment, the associated outcomes for the interaction data may be first call resolution (FCR) data. A variant of the FCR data may be first call resolution within seven days (FCR7) data, which takes into account whether a second interaction between a customer and agent was necessary for the same matter or context within seven days of the first interaction. In an embodiment the associated outcomes for the interaction data may be customer satisfaction survey results. Similar metrics to FCR that account for different types of interactions handled by a contact center 100 may also be used to determine associated outcomes for the interaction data.

The historical database may also contain information concerning the agents that were noted as available agents for the contact center during the set time interval. The historic database may provide additional granularity of detail for when an agent was available to handle an interaction routed through the contact center. For example, the historic database may provide the specific days for when an agent was marked as available to handle an interaction. The historic database may also provide specific shifts, hours, or minutes of the day when an agent was marked as available to handle an interaction.

As disclosed further below, in an embodiment, it may be advantageous to recreate the original routing scenario as close as possible for modeling and simulating the contact center with predictive routing. Accordingly, it may be desirable for the choice of agents to be the same as that of the existing baseline routing, at the granularity of a day. In other words, while scoring an interaction using the predictive model, the model is constrained to consider only those agents who had handled calls through baseline routing on the day of the interaction. In addition, the historical database may contain additional characteristics of agents, such as whether an agent was assigned to handle specific types of interactions (based on context or communication-type), or otherwise grouped within the pool of agents. In an embodiment, when additional limits or groupings of agents are deployed in the contact center, it may be desirable to choose the values of those setting as the same as applicable on the day of the interaction (i.e., selecting one of the interactions handled by an agent on that day and extract those corresponding values.)

In an embodiment, it may be assumed that an agent profile is the same for the extracted granularity of the agent information. For example, agent information is available at a day-by-day level of granularity, then it may be assumed that the agent profile remains the same throughout the given day.

At operation 304, partitioning of the extracted historic dataset from a contact center database occurs. In an embodiment, a split of the historic dataset into two temporal periods occurs at operation 304. For example, a historic dataset containing data (e.g., interaction data, agent data, and customer data) has been extracted for the specific months for a given calendar year (e.g., January through October). In this example, it is desired that the partition of operation 304 creates an 80:20 split of the extracted historic dataset, and thus creates two datasets: one containing the extracted interaction data, agent data, and customer data for January through August; and one containing the extracted interaction data, agent data, and customer data for September through October. In an embodiment, the earliest temporal partition of the historic dataset is used to create the training dataset in operation 306, while the latest temporal partition of the historic dataset is used to create the test dataset in operation 310.

At operation 308, a predictive model of the interaction routing from the contact center is created utilizing the training dataset from operation 306. In an embodiment, the predictive model may use the training dataset wherein the predictive routing server applies a machine-learning algorithm, which seeks to minimize the error in difference between true outcome for a target metric of a given agent-customer interaction and a predicted outcome of the given agent-customer interaction. As an example, the predictive model is generated by inputting the training dataset through a selected machine-learning algorithm, generating a predicted outcome of each of a given agent-customer interaction from the training dataset and an error from an actual outcome for the given agent-customer interaction is determined. The machine-learning algorithm continues to be applied to the predicted outcomes for the training dataset until the error across the differences predicted outcomes and actual outcomes is minimized for all of the interactions from the agent-customer interactions in the training dataset.

In an embodiment, the machine-learning algorithm applied at operation 308 to build the predictive model can be a decision tree, neural network, or other suitable approach. In an example, the model training service 204 (FIG. 2) may be used to perform operation 308 (FIG. 3), although other components of a predictive routing server 200 may be utilized as part of the model building.

In an embodiment, the predictive model is generated at operation 308 for a number of identified contexts from the interactions from the historical agent-customer interaction data. For example, a contact center 100 may have a number of contexts identified for the customer's intention of an interaction. In an example, the predictive model generated at operation 308 may seek to minimize the error within each of the identified contexts for the contact center 100.

At operation 312, the test dataset generated in operation 310 is scored using the predictive model constructed in operation 308. In an embodiment, the test dataset is scored through analyzing, by the analytics service of the predictive routing server, the test data using the predictive model. This may be accomplished by predicting an outcome score for the target metric for a given agent-customer interaction handled by an agent from a pool of simulated available agents on the day of the agent-customer interaction. An expected lift is then estimated for when each interaction is handled by its best-scored agent from the pool of simulated available agents on the day of the agent-customer interaction.

In an embodiment, the number of simulations may be set for operation 312 for how many times scoring the test dataset selects subsets of agents, whereby each subset of agents is used in one simulation. The predictive routing server determines an average across the specified number of simulations to account for the randomness in subset selection. The calculated agent availability figure may determine the size of these subsets. In an embodiment, scoring the test dataset may be performed for different agent availability percentages. For example, agent availability may be varied from 0.01, when only 1% of total agents are available, to 1, when 100% of agents are available. In another example, 50% availability uses random selections of half the total agents. In yet another example, 25% availability uses simulations that each pick a random 25% of the total number of agents.

In an embodiment, the number of samples to use from the test dataset for operation 312 may be varied. For example, the number of samples might be approximately 30 times the number of agents (i.e., an average of 30 samples per agent). It should be noted, however, that the number of samples should not exceed the number of records in the test dataset. As a result, the method of 300 would disregard the excess number and run reports for only the available number of samples in the test dataset.

In an embodiment, operation 312 may permit inclusion of a parameter to use to group interactions for estimation. For example, only agents who handled interactions of the type specified in the specified parameter value are used in the estimation for that group.

The expected lift in the target metric may be dependent on the available agent pool. In an embodiment, candidate agent pools of different sizes may be created to study the increase or decrease in lift. Agent availability may be defined as the fraction of total agents who handled calls on the day of the interaction. In an embodiment, to simulate 100% agent availability, for each interaction, all the agents who are part of the daily agent pool determined for a set day are scored and the maximum scored agent among them is agent selected by the generated predictive model. A 50% agent availability may be determined by randomly selecting half of the agents from the daily agent pool, scoring them and picking the maximum-scored agent among the selected half. In an embodiment, to ensure the estimated lift is not occurring by chance, the random selection of agents may be repeated a number of times, and then the lift is averaged across the runs. For example, the random selection and scoring of agents may be simulated 100 times, selecting the highest-scoring agent from each simulation selected, and then the 100 scores are averaged to determine the estimated lift.

In an embodiment, the scores obtained from the predictive model may be error-prone and may need to be adjusted in order for the predictive model to provide a reliable estimate. For a given historic agent-customer interaction, when the chosen agent in the predictive model based on a maximum score for a target metric matches with the agent who originally handled the interaction through the historic routing information, this information may be used to correct for bias in the predicted scores, if any exists. Since the number of interactions for which the two agents selected by the two different routing policies match is likely to be a small fraction of the total interactions, the estimation algorithm also amplifies the correction to account for other interactions where the actual agent and the predictive-routing-suggested agent do not match. The error-correction algorithm further assumes that the baseline routing had chosen agents randomly to determine the amplification factor. The estimate is expected to be accurate if either the predicted score or the amplification factor is accurate, but both could have errors associated with them that are likely to impact the estimate. The bias in the predicted score is determined based on the sample of interactions where the predictive-routing-chosen agent and the actual agents who handled them match, and this correction is amplified and applied to all the samples to account for the overall bias.

At operation 314, estimating the expected lift from the scoring of the test dataset from operation 312 is performed. The expected lift may be estimated by generating through an analytics service of the predictive routing server, whereby the expected lift is determined from where each interaction in the contact is handled by its best-scored agent from a pool of simulated available agents during a certain time period for the agent-customer interaction. The lift estimator uses the original interaction-agent assignment as captured in the historic dataset, the corresponding outcome, and the predicted scores by the developed model for the same set of interactions and agents, to estimate the performance the contact center would have seen had the agent assignment been using the predictive model. In an embodiment, the estimated lift may be determined through deployment of a doubly robust estimator, although other techniques may be applied. The expected lift may be graphically displayed through a graph which demonstrates the expected lift of the target metric for the contact center, wherein the graph contains the outcome score for the target metric.

In order to demonstrate the working of lift estimation on the scores obtained from different scoring models in operation 314 of method 300, an artificial dataset using the distribution of agent performances may be used. The agent performances may be modeled based for a selected target metric like First Call Resolution (FCR), wherein the simulation seeks to optimize by selecting agents with higher performance value. For the FCR target metric, it may be desirable to achieve a maximum value of FCR (e.g., 100% FCR or a value of 1 in decimal form). Other target metrics may be selected, that may include, but are not limited to, net promoter score (NPS) (also known as “likely to recommend”), average handle time (AHT), and retention rate. Certain target metrics, such as AHT, may seek optimization through minimization of the target metric, depending on the desired outcome of the target metric.

For example, a test dataset for estimating lift may be provided. The test dataset may include a listing of the available agents. Along with this listing, the test dataset may include a listing of included historic interactions. Contexts of the interactions, representing differences in customer intent for contacting the contact center may be included. Each of the agents may be scored in relation to each of the historical interactions, and this scoring data included in the test dataset. Then the agent that would generate the best outcome for the target metric according to the generated model can be determined by finding the highest score for each interaction and so on. Samples may then be taken in which an agent is selected for given ones the interactions. As will be appreciated, a very large number of samples can be used to generate the dataset. For example, 100,000 samples may be used according to the distribution to ensure that lack of samples is not an issue for reliable estimation. When applied to a given contact center, the underlying distributions may reflect typical real scenarios wherein different agents are skilled at handling different types of interactions (interaction types differ in the customer intent), overall performance varies across agents, and the same agent handles different types of interactions with varying degrees of success. The lift estimation may be calculated from the samples. The lift estimation may be provided in a curve in which the estimated lift is provided by comparing a baseline measurement and an estimated measurement.

Turning to an alternative embodiment of the present invention, discussion will now center on another methodology for estimating improvement or lift in a target metric associated with a predictive routing model (or, simply, “model”). As will be seen, this computational approach provides certain efficiencies that enable broader implementation of lift estimations. Additionally, it addresses an issue common to such estimates, which is the tendency for the estimates to be too large. Specifically, conventional algorithms used to estimate lift too often produce estimates that are inflated, which, as used herein, refers to predicting an excessive level of lift in the improvement of the target metric. This tendency compromises the predictions effectiveness as a sales tool—for example, when the prediction is used to sell predictive routing to contact center customers—or creates unrealistic expectations with those customers after purchase. Inflated estimates may similarly affect other applications where lift estimations are used. Present embodiments are provided to identify problem areas responsible for such inflated lift estimations and provide ways in which they may be mitigated, reduced, or minimized.

Three specific areas have been identified that contribute towards inflated lift estimations. First, conventional lift estimation algorithms assume that the availability of agents is uniformly distributed. However, if a particular agent is highly skilled, that agent's availability decreases due to increased call assignments. When making predictions, repeatedly or concurrently assigning calls to the best agents without considering those agents' limited availability, factors into lift overestimation. Second, the model's predicted outcomes are error-prone, with those errors usually further inflating lift. And, third, while it is known that as occupancy increases the performance of agents drop, current lift estimation algorithms do not accurately incorporate the true impact of occupancy levels on agent performance. This results in overestimation of lift, especially in contact centers operating at high occupancy levels. As part of this aspect of the discussion, the concept of “agent availability bias” will be introduced, and embodiments will be disclosed that correct the error this bias causes.

Accordingly, in an exemplary embodiment, a method is proposed for efficiently predicting lift in a manner that is more accurate and avoids an inflated result. Present embodiments include an algorithm for computing lift based on individual agent occupancy levels. To use this approach, the input dataset may be split into increments or timeslots, for example, one-hour timeslots or {T₁, T₂, . . . , Tₙ}. Then the lift or Lift(T) may be calculated for each timeslot using the following parameters within the algorithm below, which is referenced herein as Algorithm-1.
N←number of agents in timeslot T
C←sequence of all interactions in timeslot T
ρ(0)←1
ρ(j)←individual agent occupancy of agent j indexed in timeslot T, ∀j∈{1, 2, . . . , N}
α(j)←1−ρ(j) ∀j∈{1, 2, . . . , N}, denoting availability of agent indexed j
Xᵢ(j)←score of agent indexed j for interaction i, ∀j∈{1, 2, . . . , N}, ∀i∈C
σᵢ(k)←index of the k^{th} best scored agent in interaction i Given these parameters, Algorithm-1 may be expressed as follows for calculating Lift(T):

$$Lift ( T ) = \frac{1}{\vert C \vert} {\sum }_{i ∈ C} {\sum }_{k = 1}^{N} {\prod }_{m = 0}^{k - 1} ρ ( {σ}_{i} ( m ) ) α ( {σ}_{i} ( k ) ) {X}_{i} ( {σ}_{i} ( k ) )$$

More detail will be provided regarding the application of this algorithm, including explanation as to how it mitigates inflated estimations.

The method associated with Algorithm-1 begins with a dataset of previous interactions, such as those discussed above. The dataset may include interactions occurring over a period in which is defined a number of timeslots. For example, the period may be a day and the timeslots may be 1-hour increments within that day. According to exemplary embodiments, the dataset is divided into the hourly timeslots {T₁, T₂, . . . , Tₙ} and the sequence C of all interactions occurring within each timeslot T is determined. The number of agents N in timeslot T is also determined along with agent data, such as agent characteristic data relating to agent skill and ability. The method continues with calculating lift within each of the timeslots.

As a next step, the occupancy of each agent for the given timeslot is determined, which is denoted above as ρ(j) or occupancy of agent j. This is based on the actual portion of the timeslot that the particular agent was occupied as determined from the dataset. From this, α(j) or the availability of agent j may be calculated, as availability is equal to [1−occupancy], as indicated above.

A next step is to determine a score for each agent for each interaction for the target metric. This may be done by having the predictive routing model (or simply “model”) score each agent in relation to each interaction included in the timeslot. This parameter is noted above as Xᵢ(j), i.e., the score of agent indexed j for interaction i. The scoring is based on the models scoring of each agent based on the interaction data for the particular interaction and the agent data for particular agent.

In general, for each given interaction within the timeslot—e.g., a call coming into a contact center—there are a number of agents N that may be available to handle it, as some will be occupied when the call arrives and others will not. In normal functioning, the model will then assess the best agent from those that are available and route the call to that agent. As it is not known who will be available to take the call when it arrives, as some portion of the agents will generally always be occupied, the present embodiment proposed to mathematically simulate all possibilities to derive an expected value for the call. In doing this, the present method takes into account that not every agent has the same likelihood of being available when the call arrives, as the agents have different occupancy rates, and not every agent is rated or scored the same by the model in relation to a given interaction, which means not every agent has the same chance of being routed the call even if they are available. The present embodiment proposes to calculate the probability of each agent, or k^{th} ranked agent, being routed the call, where that probability takes into account the differences in occupancy and score ranking. This probability is then multiplied by the score associated with the agent for the interaction, which is an agent specific component of the expected value that is determined for the given interaction. When each of these agent specific components are calculated for each of the agents, the components are then summed to produce the expected value for the given interaction (or “interaction expected value”). As will be appreciated, the interaction expected value reflects the predicted score for the given interaction per operation of the predictive routing model.

As provided in Algorithm-1, this process is then repeated for each interaction within the timeslot so that a predicted score is calculated for each. These predicted scores are then summed and divided by the total number of interactions to provide an average predicted score for the target metric. This can be compared to a baseline for the target metric to determine the lift estimation for the timeslot T.

Thus, as will be appreciated, an expected lift is calculated that takes into account the real-world availability or occupancy of each agent during the actual timeslot T. So, while there may be several top agents working during the timeslot in terms of scoring related to the target metric, if those agents are occupied for most of the hour, the estimated lift properly takes this into account. As an example, assume that a first agent is a very high scorer with regard to the target metric. If the first agent is occupied 90% of the time, then Algorithm-1 is configured so that the high score associated with the first agent is discounted by the low probability that they are actually available to take the call when it arrives. That is, the agent specific component associated with the first agent is a value that reflects both the high-end score related to predicted performance and a low probability of the first agent being available.

Another aspect of Algorithm-1 is that it accurately reflects how predictive routing operates. In predictive routing, an agent is only routed a call if the agents rated above them for the type of interaction are occupied. That is, the predictive routing model scores each of the agents given the characteristics of the incoming interaction and then routes it to the agent that scores the best and is available. So, if the kth ranked agent is being routed the interaction, this means that every agent ranked above that agent, from (k−1)th ranked agent and up, is occupied. Thus, when determining the specific agent component of the expected value, Algorithm-1 includes determining the probability of that each of the agents ranked above the kth ranked agent are occupied.

So, in summary, Algorithm-1 is finding the expected value based on a more accurate mathematical estimation of the probability that a particular agent, i.e., the kth ranked agent, is routed a particular interaction. This probability of routing to a particular agent, which may be referred to as an “agent routing probability”, is based on multiplying the probability that the particular agent is not occupied by the probability that each of the agents ranked higher than the particular agent is occupied. The score of the particular agent is then multiplied by the agent routing probability in order to calculate the agent specific component that is used to derive the expected value.

Note that in the above algorithm, ρ(j) is equal to the call hours that engaged the agent during the one-hour time slot. If timeslots are smaller, the agent's call-hours must be divided by the timeslot duration to obtain ρ(j). This individual agent occupancy is different from the occupancy statistic that is defined by representing traffic intensity in call hours as a fraction of total number of agents in the one-hour timeslot. That said, for optimization of runtime, average occupancy for all agents in the concerned timeslot may be used or overall occupancy of each agent per day across all timeslots may be computed. However, these optimizations might lead to less accurate results that include inflated lift estimations. Further, in computing the point lift estimate, it will be appreciated that operational assumptions are made for the contact center. Changing operational circumstances within the contact center can make the actual lift obtained vary.

Next the point estimate of lift may be computed as a weighted mean of lift obtained in each time slot. Mathematically, this calculated estimate is given by:

$${\sum }_{i = 1}^{n} Lift ( {T}_{i} ) * {ω}_{i}$$

where ωᵢ are weights representing the fraction of call volume in Tᵢ of the total interaction or call volume summed across all timeslots.

The discussion will now turn to ways to further reduce error when using the above approach. Specifically, exemplary embodiments include methods to reduce potential error associated with lift estimations made via the above-disclosed algorithm. One type of error may be associated the score for the agents obtained from the model for each agent, as these may include error. Such error may adversely affect the accuracy of the estimated lift. In accordance with exemplary embodiments, these errors may be accounted for or reduced in the following ways.

A first example for reducing error involves agent classification scores. As will be appreciated, with this type of scoring, there are two possibilities in scoring, a positive outcome and a negative outcome. For example, either a sale is made or not made by the agent to a customer, or either a call is resolved in the first contact or not. Without loss of generality, the negative outcome may be denoted 0, and the positive outcome may be denoted 1. A first step of this method may include computing a confusion matrix, which may be done for each agent for the entire dataset. As will be appreciated, a confusion matrix is performance measurement for machine learning where an output, for example, is two classes. In such cases, a table with 4 different combinations of predicted and actual values is populated with the following: True Positive or TP (which is a predicted positive that is true), True Negative or TN (which is a predicted negative that is true), False Positive or FP (which is a predicted positive that is false), and False Negative or FN (with is a predicted negative that is false). Now, given the model's predicted versus actual outcomes as expressed by the FP, TP, FN, and TN categories, an expected predicted outcome cab be predicted for each agent. For a given agent, let E₁ and E₀ denote the expected outcome after error correction given that the model's prediction is 1 and 0, respectively. Then, E₁ and E₀ can be calculated as follows.

$${E}_{1} = 0 * ( \frac{FP}{FP + TP} ) + 1 * ( \frac{TP}{FP + TP} ) = \frac{TP}{FP + TP}$$

$${E}_{0} = 0 * ( \frac{TN}{FN + TN} ) + 1 * ( \frac{FN}{FN + TN} ) = \frac{FN}{FN + TN}$$

Then the original prediction scores for the agent are replaced by E₁ if the predicted score was 1, and by E₀ if the predicted was 0.

For cases when the estimated score does not involve this type of classification score, but instead involves a scoring on a continuum, another approach is used. An example of this type of score is average handle time, where the predicted score is a number of minutes. In such cases, which will be referred to as regression cases, a residual error is computed as the difference between the true outcome and the predicted outcome for each agent for the entire dataset. Then the minimum and maximum residual errors for the agent is computed, which are represented by Rₘᵢₙ and Rₘₐₓ respectively. For all calls for which this concerned agent is the best agent, the predicted outcome is noted. Then Rₘᵢₙ and Rₘₐₓ is added to the predicted outcomes to obtain bounds on the lift obtained. These values are then used in place of predicted outcomes to compute bounds on the lift estimate curve, with the lower band equaling predicted outcome+Rₘᵢₙ and the upper bound equaling predicted outcome+Rₘₐₓ.

In an alternative embodiment, a method is provided for expanding the applicability of Algorithm-1 so that similar lift estimations can be mathematically derived for varying occupancy levels. As will be appreciated, one of the most significant parameters in contact center operation statistics is occupancy level. Changes in occupancy levels are known to inversely affect target KPIs and lift. For example, at lower occupancy levels, agents have more free time, which leads to better agent performance. Additionally, in cases where predictive routing is used, lower occupancy means that there is a higher probably of one of the better scoring agent being available to take a particular call, which should lead to increases in lift. Since lift obtained is a function of occupancy, the impact of occupancy levels must be considered in estimated lift. Thus, the discussion will now turn to providing sensitivity analysis algorithms to compute expected lift for varying occupancy levels.

To review, in the example above, Algorithm-1 is presented for computing point estimate of lift for a single timeslot given the occupancy of the timeslot. A call-volume-based weighted sum of lifts from timeslots may then be used to obtain a single point estimate of lift that is representative of all the timeslots included in the study. This point lift estimate is computed from true occupancy as represented by the data.

With this in mind, another embodiment will now be introduced that takes a general approach of investigating the impact of varying occupancy levels on point lift estimates, which, thus, allows the computing of point lift estimates as a function of occupancy. In discussing this embodiment, other algorithms will be provided that introduce a concept referred to herein as “agent availability bias”, which is used to differentiate between the availability of agents within a particular timeslot. As will be appreciated, in the example above, it is assumed that each of the agents within a particular timeslot had the same occupancy and, hence, the same availability. This assumption is one that would increasingly fail as variance of agents' performance increases. This is where the concept of “agent availability bias” will help differentiate between the availability of agents within a timeslot. From there, an occupancy profile will be computed for timeslots given an input average occupancy across all timeslots and true occupancy of each timeslot. Once this is done, as will be seen, a point lift estimate from multiple timeslots may be computed given a single input average occupancy, which will give us an occupancy sensitivity curve.

To compute the agent availability bias for each agent, the number of calls answered by the agent as a fraction of the total number of calls in the entire dataset is computed. This gives us the probability of an agent answering a random call from the dataset. For this calculation, let N_{dataset} represent all of the agents in the dataset, and ∧ⱼ represents an agent availability bias of the j^{th} agent. Then, for a given timeslot T, per agent availability may be computed using the following parameters within the algorithm below, which is referenced herein as Algorithm-2.
N←number of agents in timeslot T
∧ⱼ←agent availability bias of the j^{th} agent
ρ←occupancy of timeslot T
α←1−ρ, denotes the availability of timeslot T
   Given these parameters, Algorithm-2 may be expressed as follows for calculating per agent availability:

$$α ( j ) ← \frac{α * N * {Λ}_{j}}{{\sum }_{j = 1}^{N} {Λ}_{j}} ∀ j ∈ \{ 1 , 2 , … , N \} , denotes per agent availability of agent indexed j$$

Now the per agent availabilities (as computed above in Algorithm-2) can be used as the individual agent availability found in Algorithm-1. Lift(T) can now be calculated using Algorithm-1 using this new way to compute availability. The parameters now are as follows.
N←number of agents in timeslot T
C←sequence of all interactions in timeslot T
ρ←occupancy of timeslot T
α←1−ρ, denotes the availability of timeslot T

$$α ( j ) ← \frac{α * N * {Λ}_{j}}{{\sum }_{j = 1}^{N} {Λ}_{j}} ∀ j ∈ \{ 1 , 2 , … , N \} ,$$

denotes per agent availability of agent indexed j
ρ(0)←1
ρ(j)←1−α(j), ∀j∈{1, 2, . . . , N}
Xᵢ(j)←score of agent indexed j for interaction i, ∀j∈{1, 2, . . . , N}, ∀i∈C
σᵢ(k)←index of the kth best scored agent in interaction i
   With the parameters defined in this way, Algorithm-1, which is provided again below, may be used to calculate Lift(T):

$$Lift ( T ) = \frac{1}{\vert C \vert} {\sum }_{i ∈ C} {\sum }_{k = 1}^{N} {\prod }_{m = 0}^{k - 1} ρ ( {σ}_{i} ( m ) ) α ( {σ}_{i} ( k ) ) {X}_{i} ( {σ}_{i} ( k ) )$$

With this, the point estimate across all timeslots can be computed.

Now that the algorithm to compute point lift estimate across multiple timeslots given the true occupancy of the timeslots or true_occupancy(Tᵢ) and average true occupancy or avg_true_occupancy, the process may proceed to computation of point lift estimate given an input average occupancy or O_{avg} across all timeslots. To be able compute the point lift estimate, it should be noted that the scaled occupancy O_{T}_{ᵢ} for each timeslot Tᵢ is needed. To that end, scaled occupancy for each timeslot may be computed given an input average occupancy and the following parameters within the algorithm provided below, which is referenced herein as Algorithm-3.
true_occupancy(Tᵢ)←true occupancy for timeslot Tᵢ, ∀i∈{1, 2, . . . , n}
avg_true_occupancy←average true occupancy across all timeslots
   Given these parameters, Algorithm-3 may be expressed as follows for calculating per agent availability:

$${O}_{{T}_{i}} ← \frac{{O}_{avg} * true\_occupancy ( Ti )}{avg\_true \_occupancy} , ∀ i ∈ \{ 1 , 2 , … , n \}$$

As will be appreciated, the algorithm proposed above, i.e., Algorithm-3, provides an occupancy profile for any given input occupancy O_{avg}. The new scaled occupancy values for each timeslot O_{T}_{ᵢ} can then be used to compute point lift estimates for each timeslot. Then a single point estimate can be computed by taking a weighted sum of point estimates for each timeslot, with call volume as the weights. This gives us the point lift estimate when the average occupancy is O_{avg}. To obtain an occupancy sensitivity curve, the value of O_{avg} is varied, for example, from a range of 0.1 to 0.9 in steps of 0.1. This produces a profile over point lift estimates for varying levels of average occupancy, the plot of which results in the desired occupancy sensitive curve.

Accordingly, a method is provided to extend the point lift estimation algorithm to varying input average occupancy levels. Additionally, a method is provided to compute a per agent availability that differentiates between agents' availability within a particular timeslot, which can be used to improve accuracy of the previously proposed point lift estimates.

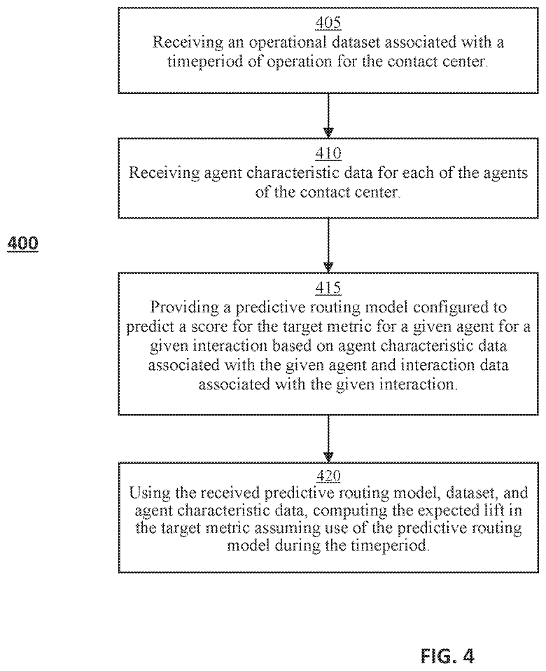

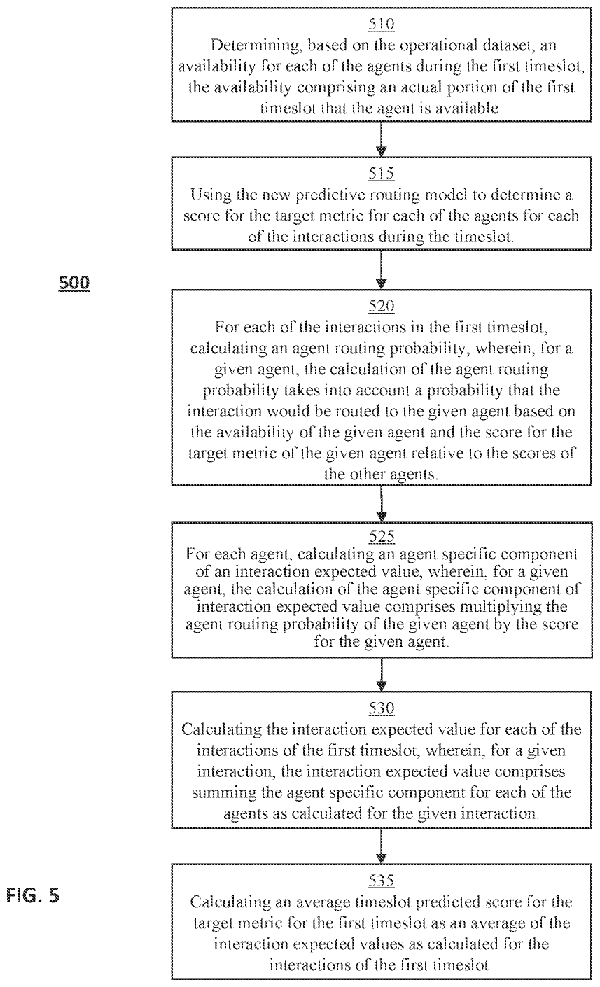

Turning now to FIGS. 4 and 5, methods 400 and 500 are provided as exemplary implementations. In FIG. 4, a method 400 is illustrated for determining operational advantages associated with prospective use by a contact center of a predictive routing model, where the operational advantages may include quantifying an expected lift in a target metric. For example, the target metric may include one of a first call resolution rate, net promoter score, and average handle time.

In accordance with exemplary embodiments, the method 400 may include a step 405 of receiving an operational dataset associated with a time period of operation for the contact center. The operational dataset may include interaction data associated with interactions with customers handled by agents of the contact center during the time period. For example, the interaction data may include data describing at least an intent and subject matter of the associated interaction.

In accordance with exemplary embodiments, the method 400 may include a step 410 of receiving agent characteristic data for each of the agents of the contact center. For example, the agent characteristic data may include data describing at least a subject matter expertise, completed training, and performance level by intent classification of the associated agent.

In accordance with exemplary embodiments, the method 400 may include a step 415 of providing the predictive routing model that is configured to predict a score for the target metric for a given agent for a given interaction based on agent characteristic data associated with the given agent and interaction data associated with the given interaction. The predictive routing model may include a machine learning model trained on historical interaction data related to past interactions in which the agent characteristic data and the interaction data for the past interactions is correlated with the respective scores achieved for the target metric for the past interactions. For example, the machine-learning algorithm may include a neural network. In certain embodiments, the step of providing the predictive routing model may include: receiving the historical interaction data; generating the predictive routing model via a machine-learning algorithm configured to minimize an error in a difference between the achieved scores for the target metric for a given past interaction and a predicted score for the given past interaction.

In accordance with exemplary embodiments, the method 400 may include a step 420 of using the received predictive routing model, dataset, and agent characteristic data, computing the expected lift in the target metric assuming use of the predictive routing model during the time period.

With reference now to FIG. 5, an algorithm or process 500 is provided by which the computation referenced above in step 420 may be completed. Specifically, the process 500 may compute the lift in the target metric based on individual agent occupancy levels. Initially, in accordance with exemplary embodiments, the time period of the operational dataset may be divided into sequentially occurring timeslots. The timeslots may include one-hour increments and the time period may include a multiple hour shift with the contact center. Then, for each timeslot of the time period, the following steps may be performed, which, when described in relation to an exemplary “first timeslot” of the timeslots, include the following.

In accordance with exemplary embodiments, the method 500 may include an initial step 510 of determining, based on the operational dataset, an availability for each of the agents during the first timeslot, the availability may include an actual portion of the first timeslot that the agent is available.

In accordance with exemplary embodiments, the method 500 may include a step 515 of using the new predictive routing model to determine a score for the target metric for each of the agents for each of the interactions during the timeslot.

In accordance with exemplary embodiments, the method 500 may include a step 520 of, for each of the interactions in the first timeslot, calculating an agent routing probability, wherein, for a given agent, the calculation of the agent routing probability takes into account a probability that the interaction would be routed to the given agent based on the availability of the given agent and the score for the target metric of the given agent relative to the scores of the other agents. The agent routing probability may include both: a chance of the given agent being available to receive the interaction when the interaction is routed; and a chance that each of the agents having a score that is superior to the given agent is not available to receive the interaction when the interaction is being routed. For example, for a given agent, the calculation of the agent routing probability may include multiplying a first probability that the given agent is available to receive the interaction by a second probability that each of the agents having a score that is superior to the given agent is not available to receive the interaction.

In accordance with exemplary embodiments, the method 500 may include a step 525 of for each agent, calculating an agent specific component of an interaction expected value, wherein, for a given agent, the calculation of the agent specific component of interaction expected value may include multiplying the agent routing probability of the given agent by the score for the given agent.

In accordance with exemplary embodiments, the method 500 may include a step 530 of calculating the interaction expected value for each of the interactions of the first timeslot, wherein, for a given interaction, the interaction expected value may include summing the agent specific component for each of the agents as calculated for the given interaction.

In accordance with exemplary embodiments, the method 500 may include a step 535 of calculating an average timeslot predicted score for the target metric for the first timeslot as an average of the interaction expected values as calculated for the interactions of the first timeslot.

From there, a time period predicted score for the target metric may be calculated based on the average timeslot predicted scores calculated for each of the timeslots. The time period predicted score for the target metric may be compared against a baseline score for the target metric for the time period to compute the expected lift. In accordance with exemplary embodiments, the step of calculating the time period predicted score for the target metric based on the average timeslot predicted scores calculated for each of the timeslots may include averaging the average timeslot predicted scores for each of the timeslots in the time period. The averaging may include calculating a weighted average in which each given timeslot is weighted in accordance with a percentage of a total interaction volume for the time period contained within the given timeslot.

In accordance with exemplary embodiments, the method may further include the step of displaying, as an output on a computer screen of a predetermined user, a comparison of the baseline score for the target metric against the computed expected lift. The displayed output may include a visual representation in which a first plot of the target metric is compared against a second plot of the target metric. The first plot may include the baseline score for the target metric, and the second plot may include the baseline score from the target metric as modified by the computed expected lift.

### Computer Systems

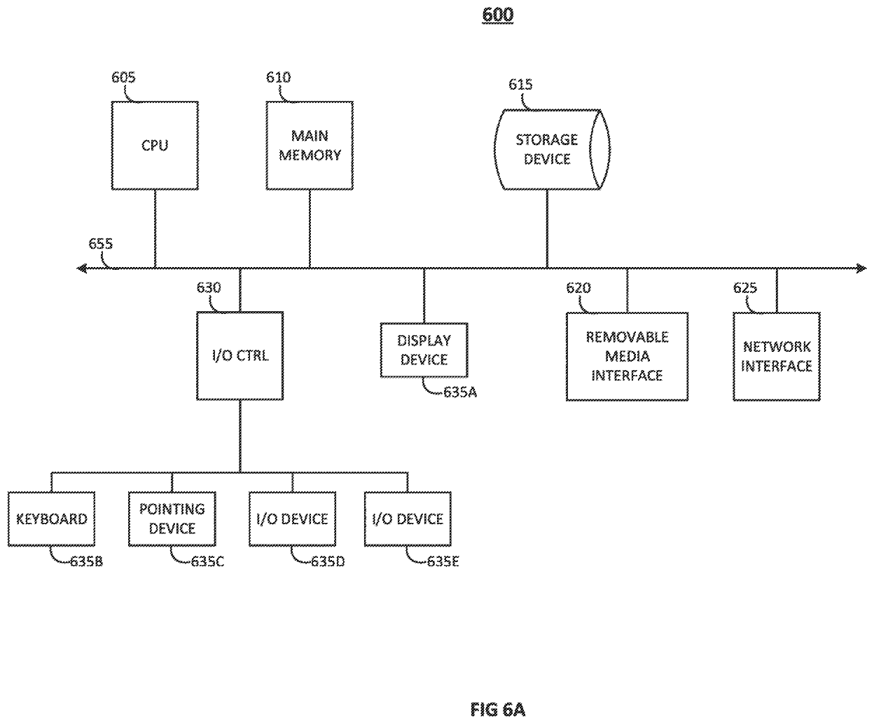

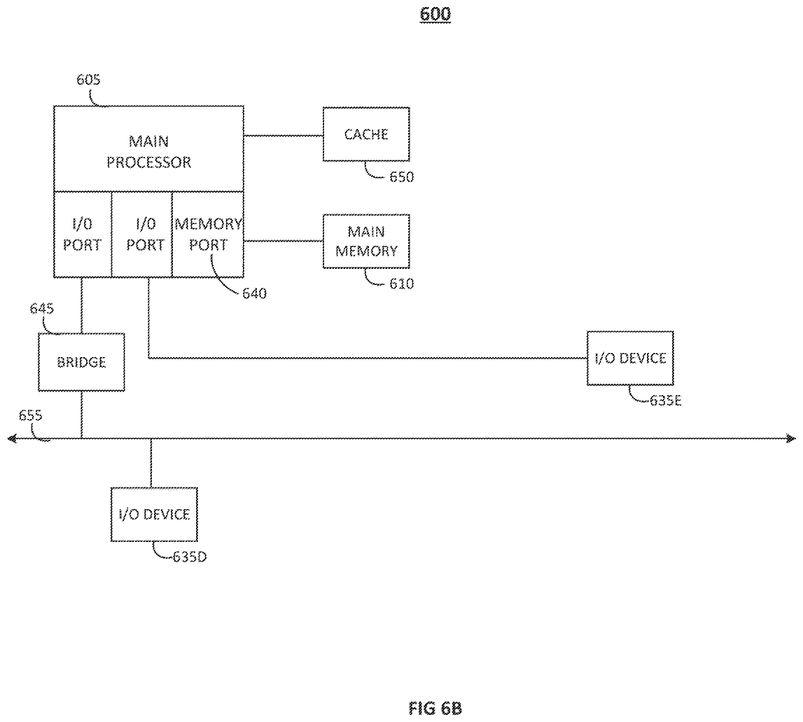

In an embodiment, each of the various servers, controls, switches, gateways, engines, and/or modules (collectively referred to as servers) in the described figures are implemented via hardware or firmware (e.g., ASIC) as will be appreciated by a person of skill in the art. Each of the various servers may be a process or thread, running on one or more processors, in one or more computing devices (e.g., FIGS. 6A, 6B), executing computer program instructions and interacting with other system components for performing the various functionalities described herein. The computer program instructions are stored in a memory which may be implemented in a computing device using a standard memory device, such as, for example, a RAM. The computer program instructions may also be stored in other non-transitory computer readable media such as, for example, a CD-ROM, a flash drive, etc. A person of skill in the art should recognize that a computing device may be implemented via firmware (e.g., an application-specific integrated circuit), hardware, or a combination of software, firmware, and hardware. A person of skill in the art should also recognize that the functionality of various computing devices may be combined or integrated into a single computing device, or the functionality of a particular computing device may be distributed across one or more other computing devices without departing from the scope of the exemplary embodiments of the present invention. A server may be a software module, which may also simply be referred to as a module. The set of modules in the contact center may include servers, and other modules.

The various servers may be located on a computing device on-site at the same physical location as the agents of the contact center or may be located off-site (or in the cloud) in a geographically different location, e.g., in a remote data center, connected to the contact center via a network such as the Internet. In addition, some of the servers may be located in a computing device on-site at the contact center while others may be located in a computing device off-site, or servers providing redundant functionality may be provided both via on-site and off-site computing devices to provide greater fault tolerance. In some embodiments, functionality provided by servers located on computing devices off-site may be accessed and provided over a virtual private network (VPN) as if such servers were on-site, or the functionality may be provided using a software as a service (SaaS) to provide functionality over the internet using various protocols, such as by exchanging data using encoded in extensible markup language (XML) or JSON.

FIGS. 6A and 6B are diagrams illustrating an embodiment of a computing device as may be employed in an embodiment of the invention, indicated generally at 600. Each computing device 600 includes a CPU 605 and a main memory unit 610. As illustrated in FIG. 6A, the computing device 600 may also include a storage device 615, a removable media interface 620, a network interface 625, an input/output (I/O) controller 630, one or more display devices 635A, a keyboard 635B and a pointing device 635C (e.g., a mouse). The storage device 615 may include, without limitation, storage for an operating system and software. As shown in FIG. 6B, each computing device 600 may also include additional optional elements, such as a memory port 640, a bridge 645, one or more additional input/output devices 635D, 635E, and a cache memory 650 in communication with the CPU 605. The input/output devices 635A, 635B, 635C, 635D, and 635E may collectively be referred to herein as 635.

The CPU 605 is any logic circuitry that responds to and processes instructions fetched from the main memory unit 610. It may be implemented, for example, in an integrated circuit, in the form of a microprocessor, microcontroller, or graphics processing unit, or in a field-programmable gate array (FPGA) or application-specific integrated circuit (ASIC). The main memory unit 610 may be one or more memory chips capable of storing data and allowing any storage location to be directly accessed by the central processing unit 605. As shown in FIG. 6A, the central processing unit 605 communicates with the main memory 610 via a system bus 655. As shown in FIG. 6B, the central processing unit 605 may also communicate directly with the main memory 610 via a memory port 640.

In an embodiment, the CPU 605 may include a plurality of processors and may provide functionality for simultaneous execution of instructions or for simultaneous execution of one instruction on more than one piece of data. In an embodiment, the computing device 600 may include a parallel processor with one or more cores. In an embodiment, the computing device 600 includes a shared memory parallel device, with multiple processors and/or multiple processor cores, accessing all available memory as a single global address space. In another embodiment, the computing device 600 is a distributed memory parallel device with multiple processors each accessing local memory only. The computing device 600 may have both some memory which is shared and some which may only be accessed by particular processors or subsets of processors. The CPU 605 may include a multicore microprocessor, which combines two or more independent processors into a single package, e.g., into a single integrated circuit (IC). For example, the computing device 600 may include at least one CPU 605 and at least one graphics processing unit.

In an embodiment, a CPU 605 provides single instruction multiple data (SIMD) functionality, e.g., execution of a single instruction simultaneously on multiple pieces of data. In another embodiment, several processors in the CPU 605 may provide functionality for execution of multiple instructions simultaneously on multiple pieces of data (MIMD). The CPU 605 may also use any combination of SIMD and MIMD cores in a single device.

FIG. 6B depicts an embodiment in which the CPU 605 communicates directly with cache memory 650 via a secondary bus, sometimes referred to as a backside bus. In other embodiments, the CPU 605 communicates with the cache memory 650 using the system bus 655. The cache memory 650 typically has a faster response time than main memory 610. As illustrated in FIG. 6A, the CPU 605 communicates with various I/O devices 635 via the local system bus 655. Various buses may be used as the local system bus 655, including, but not limited to, a Video Electronics Standards Association (VESA) Local bus (VLB), an Industry Standard Architecture (ISA) bus, an Extended Industry Standard Architecture (EISA) bus, a Micro Channel Architecture (MCA) bus, a Peripheral Component Interconnect (PCI) bus, a PCI Extended (PCI-X) bus, a PCI-Express bus, or a NuBus. For embodiments in which an I/O device is a display device 635A, the CPU 605 may communicate with the display device 635A through an Advanced Graphics Port (AGP). FIG. 6B depicts an embodiment of a computer 600 in which the CPU 605 communicates directly with I/O device 635E. FIG. 6B also depicts an embodiment in which local buses and direct communication are mixed: the CPU 605 communicates with I/O device 635D using a local system bus 655 while communicating with I/O device 635E directly.

A wide variety of I/O devices 635 may be present in the computing device 600. Input devices include one or more keyboards 635B, mice, trackpads, trackballs, microphones, and drawing tables, to name a few non-limiting examples. Output devices include video display devices 635A, speakers and printers. An I/O controller 630 as shown in FIG. 6A, may control the one or more I/O devices, such as a keyboard 635B and a pointing device 635C (e.g., a mouse or optical pen), for example.

Referring again to FIG. 6A, the computing device 600 may support one or more removable media interfaces 620, such as a floppy disk drive, a CD-ROM drive, a DVD-ROM drive, tape drives of various formats, a USB port, a Secure Digital or COMPACT FLASH™ memory card port, or any other device suitable for reading data from read-only media, or for reading data from, or writing data to, read-write media. An I/O device 635 may be a bridge between the system bus 655 and a removable media interface 620.

The removable media interface 620 may, for example, be used for installing software and programs. The computing device 600 may further include a storage device 615, such as one or more hard disk drives or hard disk drive arrays, for storing an operating system and other related software, and for storing application software programs. Optionally, a removable media interface 620 may also be used as the storage device. For example, the operating system and the software may be run from a bootable medium, for example, a bootable CD.

In an embodiment, the computing device 600 may include or be connected to multiple display devices 635A, which each may be of the same or different type and/or form. As such, any of the I/O devices 635 and/or the I/O controller 630 may include any type and/or form of suitable hardware, software, or combination of hardware and software to support, enable or provide for the connection to, and use of, multiple display devices 635A by the computing device 600. For example, the computing device 600 may include any type and/or form of video adapter, video card, driver, and/or library to interface, communicate, connect or otherwise use the display devices 635A. In an embodiment, a video adapter may include multiple connectors to interface to multiple display devices 635A. In another embodiment, the computing device 600 may include multiple video adapters, with each video adapter connected to one or more of the display devices 635A. In other embodiments, one or more of the display devices 635A may be provided by one or more other computing devices, connected, for example, to the computing device 600 via a network. These embodiments may include any type of software designed and constructed to use the display device of another computing device as a second display device 635A for the computing device 600. One of ordinary skill in the art will recognize and appreciate the various ways and embodiments that a computing device 600 may be configured to have multiple display devices 635A.

An embodiment of a computing device indicated generally in FIGS. 6A and 6B may operate under the control of an operating system, which controls scheduling of tasks and access to system resources. The computing device 600 may be running any operating system, any embedded operating system, any real-time operating system, any open source operation system, any proprietary operating system, any operating systems for mobile computing devices, or any other operating system capable of running on the computing device and performing the operations described herein.

The computing device 600 may be any workstation, desktop computer, laptop or notebook computer, server machine, handled computer, mobile telephone or other portable telecommunication device, media playing device, gaming system, mobile computing device, or any other type and/or form of computing, telecommunications or media device that is capable of communication and that has sufficient processor power and memory capacity to perform the operations described herein. In some embodiments, the computing device 600 may have different processors, operating systems, and input devices consistent with the device.

In other embodiments, the computing device 600 is a mobile device. Examples might include a Java-enabled cellular telephone or personal digital assistant (PDA), a smart phone, a digital audio player, or a portable media player. In an embodiment, the computing device 600 includes a combination of devices, such as a mobile phone combined with a digital audio player or portable media player.

A computing device 600 may be one of a plurality of machines connected by a network, or it may include a plurality of machines so connected. A network environment may include one or more local machine(s), client(s), client node(s), client machine(s), client computer(s), client device(s), endpoint(s), or endpoint node(s) in communication with one or more remote machines (which may also be generally referred to as server machines or remote machines) via one or more networks. In an embodiment, a local machine has the capacity to function as both a client node seeking access to resources provided by a server machine and as a server machine providing access to hosted resources for other clients. The network may be LAN or WAN links, broadband connections, wireless connections, or a combination of any or all of the above. Connections may be established using a variety of communication protocols. In one embodiment, the computing device 600 communicates with other computing devices 600 via any type and/or form of gateway or tunneling protocol such as Secure Socket Layer (SSL) or Transport Layer Security (TLS). The network interface may include a built-in network adapter, such as a network interface card, suitable for interfacing the computing device to any type of network capable of communication and performing the operations described herein. An I/O device may be a bridge between the system bus and an external communication bus.

In an embodiment, a network environment may be a virtual network environment where the various components of the network are virtualized. For example, the various machines may be virtual machines implemented as a software-based computer running on a physical machine. The virtual machines may share the same operating system. In other embodiments, different operating system may be run on each virtual machine instance. In an embodiment, a “hypervisor” type of virtualizing is implemented where multiple virtual machines run on the same host physical machine, each acting as if it has its own dedicated box. The virtual machines may also run on different host physical machines.

Other types of virtualization are also contemplated, such as, for example, the network (e.g., via Software Defined Networking (SDN)). Functions, such as functions of session border controller and other types of functions, may also be virtualized, such as, for example, via Network Functions Virtualization (NFV).

In an embodiment, the use of LSH to automatically discover carrier audio messages in a large set of pre-connected audio recordings may be applied in the support process of media services for a contact center environment. For example, this can assist with the call analysis process for a contact center and removes the need to have humans listen to a large set of audio recordings to discover new carrier audio messages.

As one of skill in the art will appreciate, the many varying features and configurations described above in relation to the several exemplary embodiments may be further selectively applied to form the other possible embodiments of the present invention. For the sake of brevity and taking into account the abilities of one of ordinary skill in the art, each of the possible iterations is not provided or discussed in detail, though all combinations and possible embodiments embraced by the several claims below or otherwise are intended to be part of the instant application. In addition, from the above description of several exemplary embodiments of the invention, those skilled in the art will perceive improvements, changes and modifications. Such improvements, changes and modifications within the skill of the art are also intended to be covered by the appended claims.

That which is claimed:

1. A method of determining operational advantages associated with prospective use by a contact center of a predictive routing model, wherein the operational advantages include quantifying an expected lift in a target metric, the method comprising the steps of:
receiving an operational dataset associated with a time period of operation for the contact center, the operational dataset comprising interaction data associated with interactions with customers handled by agents of the contact center during the time period;
receiving agent characteristic data for each of the agents of the contact center;
providing the predictive routing model that is configured to predict a score for the target metric for a given agent for a given interaction based on agent characteristic data associated with the given agent and interaction data associated with the given interaction; and
using the received predictive routing model, operational dataset, and agent characteristic data, computing, via a first algorithm, the expected lift in the target metric assuming use of the predictive routing model during the time period;
wherein the first algorithm computes the lift in the target metric based on individual agent occupancy levels pursuant to the steps of:
dividing the time period of the operational dataset into sequentially occurring timeslots;
for each timeslot of the time period, performing the following steps, which, when described in relation to an exemplary first timeslot of the timeslots, include:
determining, based on the operational dataset, an availability for each of the agents during the first timeslot, the availability comprising an actual portion of the first timeslot that the agent is available;
using the new predictive routing model to determine a score for the target metric for each of the agents for each of the interactions during the timeslot;
for each of the interactions in the first timeslot, calculating an agent routing probability, wherein for a given agent, wherein the calculation of the agent routing probability takes into account a probability that the interaction would be routed to the given agent based on the availability of the given agent and the score for the target metric of the given agent relative to the scores of the other agents;
for each agent, calculating an agent specific component of an interaction expected value, wherein for a given agent the calculation of the agent specific component of interaction expected value comprises multiplying the agent routing probability of the given agent by the score for the given agent;
calculating the interaction expected value for each of the interactions of the first timeslot, wherein, for a given interaction, the interaction expected value comprises summing the agent specific component for each of the agents as calculated for the given interaction;
calculating an average timeslot predicted score for the target metric for the first timeslot as an average of the interaction expected values as calculated for the interactions of the first timeslot;
calculating, based on the average timeslot predicted scores calculated for each of the timeslots, a time period predicted score for the target metric; and
comparing the time period predicted score for the target metric against a baseline score for the target metric for the time period to compute the expected lift.

2. The method of claim 1, further comprising the step of displaying, as an output on a computer screen of a predetermined user, a comparison of the baseline score for the target metric against the computed expected lift.

3. The method of claim 2, wherein the timeslots comprise one-hour increments and the time period comprises a multiple hour shift with the contact center.

4. The method of claim 2, wherein the displayed output comprises a visual representation in which a first plot of the target metric is compared against a second plot of the target metric; and
wherein:
the first plot comprises the baseline score for the target metric; and
the second plot comprises the baseline score from the target metric as modified by the computed expected lift.

5. The method of claim 2, wherein the step of calculating the time period predicted score for the target metric based on the average timeslot predicted scores calculated for each of the timeslots comprises:
averaging the average timeslot predicted scores for each of the timeslots in the time period.

6. The method of claim 5, wherein the averaging comprises calculating a weighted average in which each given timeslot is weighted in accordance with a percentage of a total interaction volume for the time period contained within the given timeslot.

7. The method of claim 2, wherein, for a given agent, the agent routing probability includes both:
a chance of the given agent being available to receive the interaction when the interaction is routed; and
a chance that each of the agents having a score that is superior to the given agent is not available to receive the interaction when the interaction is being routed.

8. The method of claim 2, wherein, for a given agent, the calculation of the agent routing probability comprises multiplying a first probability that the given agent is available to receive the interaction by a second probability that each of the agents having a score that is superior to the given agent is not available to receive the interaction.

9. The method of claim 8, wherein:
the interaction data comprises data describing at least an intent and subject matter of the associated interaction; and
the agent characteristic data comprise data describing at least a subject matter expertise, completed training, and performance level by intent classification of the associated agent.

10. The method of claim 9, wherein the predictive routing model comprises a machine learning model trained on historical interaction data related to past interactions in which the agent characteristic data and the interaction data for the past interactions is correlated with the respective scores achieved for the target metric for the past interactions.

11. The method of claim 10, wherein the step of providing the predictive routing model comprises:
receiving the historical interaction data;
generating the predictive routing model via a machine-learning algorithm configured to minimize an error in a difference between the achieved scores for the target metric for a given past interaction and a predicted score for the given past interaction.

12. The method of claim 11, wherein the target metric comprises one of a first call resolution rate, net promoter score, and average handle time; and
wherein the machine-learning algorithm comprises a neural network.

13. A system for determining operational advantages associated with prospective use by a contact center of a predictive routing model, wherein the operational advantages include quantifying an expected lift in a target metric, the system comprising:
at least one processor; and
at least one memory comprising a plurality of instructions stored therein that, in response to execution by the at least one processor, causes the system to perform the following steps:
receiving an operational dataset associated with a time period of operation for the contact center, the operational dataset comprising interaction data associated with interactions with customers handled by agents of the contact center during the time period;
receiving agent characteristic data for each of the agents of the contact center;
providing the predictive routing model that is configured to predict a score for the target metric for a given agent for a given interaction based on agent characteristic data associated with the given agent and interaction data associated with the given interaction;
using the received predictive routing model, operational dataset, and agent characteristic data, computing, via a first algorithm, the expected lift in the target metric assuming use of the predictive routing model during the time period;
wherein the first algorithm computes the lift in the target metric based on individual agent occupancy levels pursuant to the steps of:
dividing the time period of the operational dataset into sequentially occurring timeslots;
for each timeslot of the time period, performing the following steps, which, when described in relation to an exemplary first timeslot of the timeslots, include:
determining, based on the operational dataset, an availability for each of the agents during the first timeslot, the availability comprising an actual portion of the first timeslot that the agent is available;
using the new predictive routing model to determine a score for the target metric for each of the agents for each of the interactions during the timeslot;
for each of the interactions in the first timeslot, calculating an agent routing probability, wherein, for a given agent, the calculation of the agent routing probability takes into account a probability that the interaction would be routed to the given agent based on the availability of the given agent and the score for the target metric of the given agent relative to the scores of the other agents;
for each agent, calculating an agent specific component of an interaction expected value, wherein, for a given agent, the calculation of the agent specific component of interaction expected value comprises multiplying the agent routing probability of the given agent by the score for the given agent;
calculating the interaction expected value for each of the interactions of the first timeslot, wherein, for a given interaction, the interaction expected value comprises summing the agent specific component for each of the agents as calculated for the given interaction;
calculating an average timeslot predicted score for the target metric for the first timeslot as an average of the interaction expected values as calculated for the interactions of the first timeslot;
calculating, based on the average timeslot predicted scores calculated for each of the timeslots, a time period predicted score for the target metric; and
comparing the time period predicted score for the target metric against a baseline score for the target metric for the time period to compute the expected lift.

14. The system of claim 13, wherein the plurality of instructions stored in the memory, in response to execution by the at least one processor, causes the system to further perform the step of:
of displaying, as an output on a computer screen of a predetermined user, a comparison of the baseline score for the target metric against the computed expected lift.

15. The system of claim 14, wherein the displayed output comprises a visual representation in which a first plot of the target metric is compared against a second plot of the target metric; and
wherein:
the first plot comprises the baseline score for the target metric; and
the second plot comprises the baseline score from the target metric as modified by the computed expected lift.

16. The system of claim 14, wherein the step of calculating the time period predicted score for the target metric based on the average timeslot predicted scores calculated for each of the timeslots comprises:
averaging the average timeslot predicted scores for each of the timeslots in the time period.

17. The system of claim 14, wherein, for a given agent, the agent routing probability includes both:
a chance of the given agent being available to receive the interaction when the interaction is routed; and
a chance that each of the agents having a score that is superior to the given agent is not available to receive the interaction when the interaction is being routed.

18. The system of claim 14, wherein, for a given agent, the calculation of the agent routing probability comprises multiplying a first probability that the given agent is available to receive the interaction by a second probability that each of the agents having a score that is superior to the given agent is not available to receive the interaction.

19. The system of claim 18, wherein:
the interaction data comprises data describing at least an intent and subject matter of the associated interaction; and
the agent characteristic data comprise data describing at least a subject matter expertise, completed training, and performance level by intent classification of the associated agent.

20. The system of claim 19, wherein the predictive routing model comprises a machine learning model trained on historical interaction data related to past interactions in which the agent characteristic data and the interaction data for the past interactions is correlated with the respective scores achieved for the target metric for the past interactions.
